(19) United States
(12) Patent Application Publication
(10) Pub. No.: US 2011/0175944 A1
(43) Pub. Date: Jul. 21, 2011

(54) CONTROL SYSTEM FOR MAINTAINING COLOR OF A DISPLAY DEVICE

(75) Inventors: Jung-Ming Kuo, TAINAN COUNTY (TW); Chin-Hsuan Li, TAINAN COUNTY (TW); Wen-Chan Wu, KAOHSIUNG COUNTY (TW)

(73) Assignee: CHI LIN TECHNOLOGY CO., LTD., TAINAN COUNTY (TW)

(21) Appl. No.: 13/009,006

(22) Filed: Jan. 19, 2011

(30) Foreign Application Priority Data
Jan. 21, 2010 (TW) 099101604

(51) Int. Cl. G09G 5/10

(52) U.S. Cl. 345/690

(57) ABSTRACT

A control system is used for maintaining color of a display device, wherein the color is g formed by brightness of a first, second and a third color elements. The first, second and the third color elements have a first brightness, second brightness and a third brightness respectively and a luminance ratio of the first brightness, second brightness and the third brightness. The control system comprises a light-detecting member, a processing unit and a light source driver. The light-detecting member is used for detecting brightness of the first, second and the third color elements. The processing unit is used for calculating a first attenuation brightness of the first color element, second attenuation brightness of the second color element and a third attenuation brightness of the third color element. The light source driver is used for adjusting brightness of the first, second and the third color elements when the first attenuation brightness reaches a first compensated brightness of the first color element, the processing unit controls the light source driver to respectively adjust the first, second and the third brightness into a first, second and the third default brightness based on the first default brightness and the luminance ratio of the first brightness, second brightness and the third brightness, wherein, the difference of brightness between the first brightness and the first default brightness is the first compensated brightness.

This application claims the benefits of the Taiwan Patent Application Serial NO. 099101604 filed on Jan. 21, 2010, the subject matter of which is incorporated herein by reference.

### BACKGROUND OF THE INVENTION

1. Field of the Invention

The present invention relates to a control system, more particularly to a control system for maintaining the color of a display device.

2. Description of the Prior Art

The basic principle of colored display is to combine red, blue and green light beams. In a LED colored display, the red, blue and the green light are respectively emitted from red LED, blue LED and green LED, which are activated independently or collectively by means of a light source driver to control the brightness and color of the colored display.

In case that any of red, blue or green lights decreases its brightness to a predetermined brightness, there may be biasing of the luminance ratio.

For example, please refer to the following tables, wherein table 1 shows the brightness quality (status) of the colored display at the initial stage of use, table 2 shows an brightness attenuation status of the colored display after one year of use, and table 3 shows an attenuation status of the colored display after 5 years of use. The maximum current of the red, blue and the green colors are 70 mA, 180 mA and 20 mA respectively.

TABLE 1

| | Fully lighted (nits)@ | Target brightness | Adjusted |
|---|---|---|---|
| | maximum current | (nits) | current (mA) |
| Red | 700 (nits)@I = 70 mA | 500 (nits) | I = 50 mA |
| Blue | 1800 (nits)@I = 180 mA | 1400 (nits) | I = 140 mA |
| Green | 200 (nits)@I = 20 mA | 100 (nits) | I = 10 mA |

The adjusted current of red, blue and green lights does not exceed the brightness of its respective maximum current(/fully lighted). In other words, the colored display is qualified. The overall brightness of the colored display is 500+1400+100=2000 (nits), and the luminance ratio of the red, blue or the green light for maintaining the target brightness of the colored display is 500:1400:100=5:14:1 in order to maintain a certain color of the colored display.

TABLE 2

| | Fully lighted (nits)@ | Target brightness | Adjusted |
|---|---|---|---|
| | maximum current | (nits) | current (mA) |
| Red | 600 (nits)@I = 70 mA | 500 (nits) | I = 58 mA |
| Blue | 1700 (nits)@I = 180 mA | 1400 (nits) | I = 148 mA |
| Green | 180 (nits)@I = 20 mA | 100 (nits) | I = 11 mA |

After one year of use, although the adjusted currents of the red, blue and the green LEDs will increase to maintain the target brightness, these adjusted currents still does met exceed the maximum current(/fully lighted). In other words, although the colored display consumes more power for maintaining the target brightness, the color and the brightness of the colored display are not biased.

TABLE 3

| | Fully lighted (nits)@ | Target brightness | Adjusted |
|---|---|---|---|
| | maximum current | (nits) | current (mA) |
| Red | 400 (nits)@I = 70 mA | 500 (nits) | I = 87 mA |
| Blue | 1600 (nits)@I = 180 mA | 1400 (nits) | I = 157 mA |
| Green | 160 (nits)@I = 20 mA | 100 (nits) | I = 12.5 mA |

After five years of use, the brightness of the fully lighted condition attenuates seriously and therefore the adjusted current of the red, blue and the green LEDs will increase much more than before to maintain its respective Target brightness, especially note the adjusted current of red is as high as 87 mA, which has been more than the red brightness in the fully lighted condition or the maximum current 70 mA. In other words, the adjusted brightness of the red color is more than the maximum current (/fully lighted).

Because the red color has been decreased to 400 (nits), and the blue or the green light has respectively kept at 1400 (nits) and 100 (nits), the luminance ratio of the red, blue or the green light is now 4:2:1, rather than the original 5:14:1, and thus the color and the brightness of the colored display are biased.

Moreover, some colored displays are capable of increasing the current of the red color in case the brightness of red light source is insufficient. The result may cause the red light source or the cooling system of the colored display rapid aging or failure.

The present invention is to provide a control system to maintain the color of the display device and to improve the above-stated problems.

### SUMMARY OF THE INVENTION

Therefore, the object of the present invention is to provide a control system to be applied within a display device in order to maintain the color of the display device, thereby preventing occurrence of biasing due to over supply of brightness and due to attenuation of a certain color. The display device is thus prevented from rapid failure in the heat dissipating or cooling system.

A control system is used for maintaining color of a display device, wherein the color is formed by brightness of a first, second and a third color elements. The first, second and the third color elements have a first brightness, second brightness and a third brightness respectively and a luminance ratio of the first brightness, second brightness and the third brightness. The control system comprises a light-detecting member, a processing unit and a light source driver. The light-detecting member is used for detecting brightness of the first, second and the third color elements. The processing unit is used for calculating a first attenuation brightness of the first color element, second attenuation brightness of the second color element and a third attenuation brightness of the third color element. The light source driver is used for adjusting brightness of the first, second and the third color elements when the first attenuation brightness reaches a first compensated brightness of the first color element, the processing unit controls the light source driver to respectively adjust the first, second and the third brightness into a first, second and the third default brightness based on the first default brightness and the luminance ratio of the first brightness, second brightness and the third brightness, wherein, the difference of brightness between the first brightness and the first default brightness is the first compensated brightness.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a schematic view of light source units of a display device of the present invention; and

FIG. 2 shows the control system for controlling the display device of the present invention and related elements.

### DETAILED DESCRIPTION OF THE PREFERRED EMBODIMENT

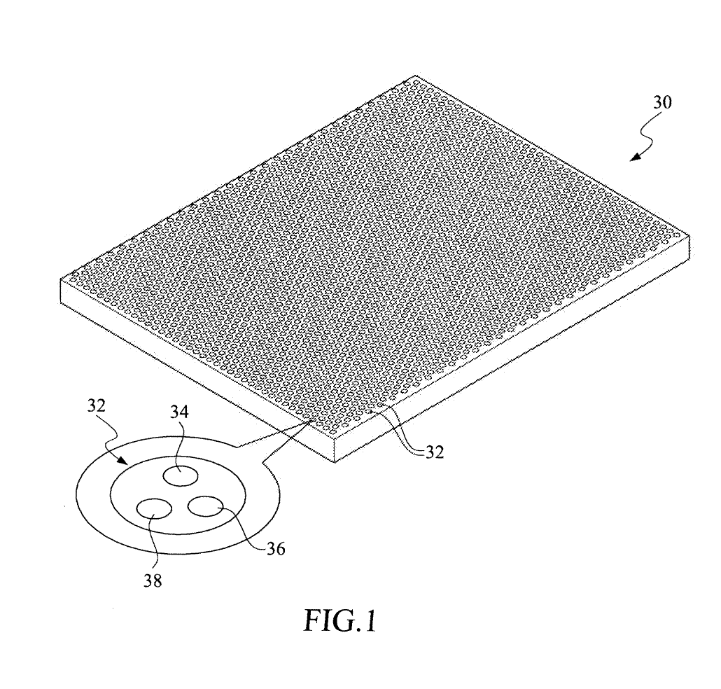

FIG. 1 shows a schematic view of light source units of a display device 30 of the present invention. The display device 30 includes a plurality of light source units 32. Each light source unit 32 includes a first color element 34, second color element 36 and a third color element 38. In the preferred embodiment, the first, second and the third color elements 34, 36, 38 are represented by red, blue and green LED/LEDs. In other embodiments, the first color element 34 is represented by blue or green LED/LEDs.

In the present invention, at least two different color elements are implemented. But for purpose of better understanding, three different color elements (for example: red, blue, green) are used for illustration. However, the limitation should not be set only to the three color elements.

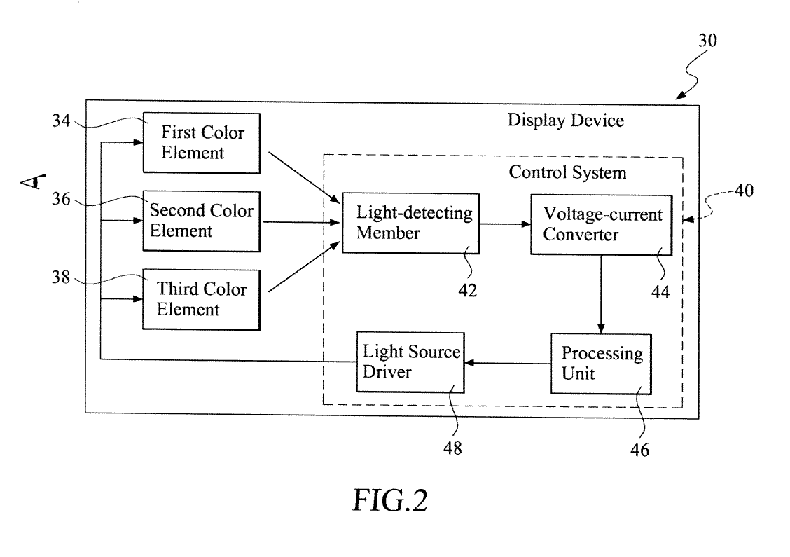

FIG. 2 shows the control system 40 for controlling the display device 30 of the present invention and related elements. The control system 40 is applied in the display device 30 in order to control the brightness and color of the display device 30. The brightness and color of the display device 30 are formed by cooperation of the first, the second and the third color elements 34, 36 and 38 according to a luminance ratio of the first brightness, second brightness and the third brightness.

For safety consideration to the display device 30, each of these color elements is set with a corresponding compensated brightness. The first, second and the third color elements 34, 36, 38 have a proportional relationship, i.e. a luminance ratio of the first brightness, second brightness and the third brightness, wherein the tables 1˜3 respectively show the brightness 500 nits, 1400 nits and 100 nits or the luminance ratio of the first brightness, second brightness and the third brightness is 5:14:1.

The control system 40 includes a light-detecting member 42, a voltage-current converter 44, a processing unit 46 and a light source driver 48.

The light-detecting member 42 is used for detecting a first brightness of the first element 34, a second brightness of the second element 36, a third brightness of the third color element 38. With long term use, the first brightness, second brightness and the third brightness are subjected to attenuation.

The light-detecting member 42 is capable of detecting a current signal, which is converted by the voltage-current converter 44 into a voltage signal for the processing unit 46. In other words, the voltage-current converter 44 is capable of converting the current signals of the first, second and the third brightness into the voltage signals so that the processing unit 46 can identify the voltage signals for undergoing a calculation process.

In the preferred embodiment, the processing unit 46 is a color microprocessor for calculating a first attenuation brightness of the first color element 34, a second attenuation brightness of the second color element 36 and a third attenuation brightness of the third color element 38.

The light source driver 48 adjusts the brightness of the first, second and the third color elements 34, 36 and 38. When the first attenuation brightness reaches a first compensated brightness of the first color element 34, the processing unit 46 controls the light source driver 48 to respectively adjust the first, second and the third brightness into a first, second and a third default brightness based on the first default brightness and the luminance ratio of the first brightness, second brightness and the third brightness, wherein the difference of brightness between the first brightness and the first default brightness is the first compensated brightness, wherein the first compensated brightness of the first color element 34, a second compensated brightness of the second color element 36 and a third compensated brightness of the third color element 36 are set in advance.

In the present invention, one of the attenuation brightness reaches correspondence to the compensated brightness at the earliest as the first color element.

The following table 4 shows the adjustment done by the control system of the present invention relative to the table 3 for the color attenuation after 5 years use of the display device 30.

TABLE 4

| | Fully lighted (nits)@ | Target brightness | Adjusted |
|---|---|---|---|
| | maximum current | (nits) | current (mA) |
| Red | 400 (nits)@I = 70 mA | 400 (nits) | I = 70 mA |
| Blue | 1600 (nits)@I = 180 mA | 1120 (nits) | I = 126 mA |
| Green | 160 (nits)@I = 20 mA | 80 (nits) | I = 10 mA |

After 5 years of use, although the brightness of the fully-lighted condition attenuates seriously and the required current value for adjusting to the target brightness becomes greater. The required current value for maintaining the red color has been reduced to 400 (nits). When the first, second and the third elements 34 are respectively red, blue and green LED/LEDs, and the first, second and the third brightness are respectively 500 (nits), 1400 (nits) and 100 (nits), and the first compensated brightness is the 100 (nits) and the first attenuation brightness is 100 (nits) and the first, second and the third default brightness are respectively 400 (nits), 1120 (nits) and 80 (nits).

The processing unit 46 at this time selects the red color, i.e., based on the first default brightness of the first color element 34 and the luminance ratio (5:14:1), and controls the light source driver 48 to re-adjust the second and the third brightness of the second and the third color elements 34, 36, 38 into the second and the third default brightness respectively.

In this embodiment, the first default brightness of the first color element 34 is 400 (nits), according to the proportional relationship luminance ratio (5:14:1), the first, second and the third default brightness are respectively 400 (nits), 1120 (nits) and 80 (nits). The overall brightness is dropped to 400+1120+80=1600 (nits).

Although the overall brightness has dropped to 1600 (nits) from 2000 (nits), but it can maintain the color of the display device 30. In practical, the consumer may not easily sense the brightness loss, but may easily sense the color bias. In addition, there will not be setting of too high current for the target brightness of the first color element for causing rapid aging to first color element or causing the cooling system of the display device 30 rapid aging or failure.

Further, the brightness, detected(/measured) by the light-detecting member 42, are converted into grey values, ex, the brightness, the default brightness, the attenuation brightness or the compensated brightness. The processing unit 46 further converts the first, second and the third brightness respectively into a first, second and a third original gray values, further converts the first, second and the third attenuation brightness respectively into a first, second and a third attenuation gray values, and further converts the first, second and the third compensated brightness respectively into a first, second and a third compensated gray values.

The processing unit 46 further calculates the first, second and the third original gray values and corresponding the first, second and the third attenuation gray values, and the first, second and the third compensated gray values.

Finally, the processing unit 46 compares, based on the luminance ratio, the first, second and the third compensated gray values, which in turn control light driver 48 to respectively adjust the first, second and the third brightness into the first, second and the third default brightness.

As stated above, the processing unit 46 controls the light driver 48 to respectively adjust the first color element 34, second color element 36 and the third color element 38, i.e. adjust the current 70 mA, 126 mA and 10 mA, in order to adjust the first, second and the third brightness to become the first default brightness, second default brightness and the third default brightness, i.e. 400 (nits), 1120 (nits) and 80 (nits), respectively.

In addition to adjustment in the current value, current pulse width can be adjusted for achieving the same purpose. Each current signal is not a full signal, but has a pulse width. The pulse width relative to the cycle is similar to the percentage of the current benefits. Such as, pulse width for the entire cycle of 70% indicates that the current benefit is only 70% in use. Adjusting pulse width is similar to adjusting the current values.

Referring to table 5˜table 8, which show the embodiments for adjusting the pulse width. In the abovementioned control system 40, the processing unit 46 controls the light source driver 48 to respectively adjust the pulse width of the first color element 34, second color elements 36 and the third color element 38 in order to convert the first, second and the third brightness into the first, second and the third default brightness respectively.

Table 5 shows the brightness quality (status) of the display device 30 at the initial stage of use, where pulse widths are used for serving as a compensation parameter. Table 6 shows the brightness attenuation status of the display device after one year of use. Table 7 shows the brightness attenuation status of the display device 30 after five years of use. Table 8 shows the inventive default brightness status of the display device 30 after five years of use. The display device 30 applies pulse width percentage of ratio (Duty value (D)) relative to the entire cycle for serving as the compensation parameters of the red, blue and the green color elements.

TABLE 5

| | | | Adjusted |
|---|---|---|---|
| | Fully lighted (nits)@ | Target brightness | brightness |
| | maximum duty | (nits) | (duty) |
| Red | 700 (nits)@D = 100% | 500 (nits) | D = 71% |
| Blue | 1800 (nits)@D = 100% | 1400 (nits) | D = 77% |
| Green | 200 (nits)@D = 100% | 100 (nits) | D = 50% |

The Duty values of the three target brightness do not exceed the Duty values of the three brightness of the fully-lighted condition or maximum duty, so that this display device 30 meets the qualified standard at the initial stage of use. The luminance ratio of the color elements for maintaining the target brightness of the display device 30 is 5:14:1, wherein this ratio can maintain a certain color.

TABLE 6

| | | | Adjusted |
|---|---|---|---|
| | Fully lighted(nits)@ | Target brightness | brightness |
| | maximum duty | (nits) | (duty) |
| Red | 600 (nits)@D = 100% | 500 (nits) | D = 83% |
| Blue | 1700 (nits)@D = 100% | 1400 (nits) | D = 82% |
| Green | 180 (nits)@D = 100% | 100 (nits) | D = 55% |

After a year of use, although the brightness of the fully-lighted condition attenuates, and the required Duty value for maintenance of the target brightness becomes greater, the required Duty of the three target brightness does not exceed the Duty values of the three brightness of the maximum Duty when the device is in the fully-lighted condition. In other words, the adjusted Duty of the three brightness are still not over these maximum duties respectively so this display device 30 is still usable.

TABLE 7

| | | | Adjusted |
|---|---|---|---|
| | Fully lighted(nits)@ | Target brightness | brightness |
| | maximum duty | (nits) | (duty) |
| Red | 400 (nits)@D = 100% | 500 (nits) | D = 125% |
| Blue | 1600 (nits)@D = 100% | 1400 (nits) | D = 87% |
| Green | 160 (nits)@D = 100% | 100 (nits) | D = 62% |

After five years of use, the brightness of the fully-lighted condition attenuates more seriously and the required Duty for adjusting the target brightness becomes higher, especially note that the required Duty for adjusting the brightness of the red color has reached 125% and is more than the maximum current (100%) in the fully-lighted condition. In other words, the required Duty of adjusting the target brightness of red color element is greater than the maximum duty.

TABLE 8

| | | | Adjusted |
|---|---|---|---|
| | Fully lighted(nits)@ | Target brightness | brightness |
| | maximum duty | (nits) | (duty) |
| Red | 400 (nits)@D = 100% | 400 (nits) | D = 100% |
| Blue | 1600 (nits)@D = 100% | 1120 (nits) | D = 70% |
| Green | 160 (nits)@D = 100% | 80 (nits) | D = 50% |

Table 7 is adjusted in order to obtain table 8, wherein table 8 shows the maximum duty (100%) corresponding to the adjusted Duty for the target brightness. The target brightness of this red color element has been reduced to 400 (nits).

Processing unit 46 selects the red color element (i.e., based on the first brightness 400 (nits) of the first color element 34 and the luminance ratio (5:14:1)) and controls the light source driver 48 to adjust the first brightness, second brightness and the third brightness into a first default brightness, second default brightness and a third default brightness. Therefore, the first default brightness, second default brightness and the third default brightness are 400 (nits), 1120 (nits), 80 (nits) respectively.

Although the overall brightness has dropped to 1600 (nits) from 2000 (nits), but it can maintain the color of the display device 30 and there is not too high current value for the maximum duty. There is no problem of rapid aging to the first color elements and rapid failure to the cooling system of the display device 30.

Therefore, the control system 40 of the present invention is applied in the display device 30 to maintain the color using the brightness of a corresponding maximum duty and a luminance ratio of the first brightness, second brightness and the third brightness to adjust the brightness of those color elements. Thus, there is no brightness attenuation at each of the color elements due to over current of the maximum duty, thereby preventing untimely aging of the color elements. Further, the control system also prevents failure of the cooling system of the display device 30.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A control system for maintaining color of a display device, the color being formed by brightness of a first and a second color elements, the first and the second color elements having a first brightness and a second brightness respectively and a luminance ratio of the first brightness and the second brightness, the control system comprising:
a light-detecting member for detecting brightness of the first and the second color elements;
a processing unit for calculating a first attenuation brightness of the first color element and a second attenuation brightness of the second color element; and
a light source driver for adjusting brightness of the first and the second color elements,
when the first attenuation brightness reaches a first compensated brightness of the first color element, the processing unit controls the light source driver to respectively adjust the first and the second brightness into a first and a second default brightness based on the first default brightness and the luminance ratio, wherein, the difference of brightness between the first brightness and the first default brightness is the first compensated brightness.

2. The control system as defined in claim 1, wherein the brightness of each of the first and the second color elements is converted into a grey value.

3. The control system as defined in claim 1, wherein the processing unit controls the light source driver to adjust a current value of a respective one of the first and the second color elements, thereby converting the first and the second brightness into the first and the second default brightness.

4. The control system as defined in claim 1, wherein the processing unit controls the light source driver to adjust a pulse width of a respective one of the first and the second color elements, thereby converting the first and the second brightness into the first and the second default brightness.

5. The control system as defined in claim 1, wherein the first color element is a red LED, a blue LED or a green LED.

6. The control system as defined in claim 1, wherein the first attenuation brightness reaches the first compensated brightness of the first color element at the earliest.

7. A control system for maintaining color of a display device, the color being formed by brightness of a first, second and a third color elements, the first, second and the third color elements having a first brightness, second brightness and a third brightness respectively and a luminance ratio of the first brightness, second brightness and the third brightness, the control system comprising:
a light-detecting member for detecting brightness of the first, second and the third color elements;
a processing unit for calculating a first attenuation brightness of the first color element, a second attenuation brightness of the second color element and a third attenuation brightness of the third color element; and
a light source driver for adjusting brightness of the first, second and the third color elements,
when the first attenuation brightness reaches a first compensated brightness of the first color element, the processing unit controls the light source driver to respectively adjust the first, second and the third brightness into a first, second and a third default brightness based on the first default brightness and the luminance ratio, wherein, the difference of brightness between the first brightness and the first default brightness is the first compensated brightness.

8. The control system as defined in claim 7, wherein the brightness of each of the first, second and the third color elements is converted into a grey value.

9. The control system as defined in claim 7, wherein the processing unit controls the light source driver to adjust a current value of a respective one of the first, second and the third color elements, thereby converting the first, second and the third brightness into the first, second and the third default brightness.

10. The control system as defined in claim 7, wherein the processing unit controls the light source driver to adjust a pulse width of a respective one of the first, second and the third color elements, thereby converting the first, second and the third brightness into the first, second and the third default brightness.

11. The control system as defined in claim 7, wherein the first color element is a red LED, a blue LED or a green LED.

12. The control system as defined in claim 7, wherein the first attenuation brightness reaches the first compensated brightness of the first color element at the earliest.
